(19) United States
(12) Patent Application Publication
(10) Pub. No.: US 2015/0135498 A1
(43) Pub. Date: May 21, 2015

(54) INTERCHANGEABLE TOOL AND RELATED TOOL SETS

(71) Applicant: Tanuki Entertainment, Inc., Lake Stevens, WA (US)

(72) Inventor: Matthew Archer Gillikin, Lake Stevens, WA (US)

(73) Assignee: Tanuki Entertainment, Inc., Lake Stevens, WA (US)

(21) Appl. No.: 14/085,490

(22) Filed: Nov. 20, 2013

(51) Int. Cl. B25B 23/00; B25B 15/00

(52) U.S. Cl. CPC B25B 23/0035; B25B 15/008
USPC 29/76.1; 279/128; 81/438; 30/165; 81/489; 81/180.1; 15/146

(57) ABSTRACT

An interchangeable tool for use with a hexagonal key having at least a first male end with six facets which form a hexagonal profile includes a first interchangeable tip comprising a body and a head extending from the body. The body includes a female receptacle having an opening open to an exterior of the first interchangeable tip, with the female receptacle having six facets that form a hexagonal profile. The hexagonal profile is sized and dimensioned to matingly receive the first male end of the hexagonal key, with the head having at least one tool element. Related interchangeable tool sets are also provided.

### BACKGROUND

1. Technical Field

The present disclosure generally relates to interchangeable tools and, more particularly, to interchangeable tools for use with hexagonal keys.

2. Description of the Related Art

Assembling or disassembling components typically involves fastening or unfastening subcomponents. Fastening or unfastening subcomponents may often involve using hexagonal keys. Examples of hexagonal keys may include right angle keys, T-shaped keys, S-shaped keys, or other types of keys.

The hexagonal keys allow users to apply a higher amount of torque than may be achievable through other fastening devices, such as a screwdriver, for example. For example, the right angle key may function as a male driving member that is received in a corresponding female member (i.e., cap screw, hex bolt, etc.). The right angle key may typically have a longer portion and a shorter portion that is at a right angle to the longer portion. In operation, rotating the right angle key by leveraging the longer portion will generally apply a higher amount of torque than leveraging the short portion. Leveraging either the longer or shorter portions may still provide more torque in comparison with other fastening devices. In a similar manner, the S-shaped or T-shaped keys may also allow application of higher torque values.

However, the corresponding female members or other fasteners are often located in narrow spaces. For instance, fasteners are often located in tight spaces, where fastening devices, such as a conventional screw driver, for example, may not have effective access due to interference with surrounding structures. Similarly, in some instances workpieces are also often located in narrow spaces with limited access. Additionally, the hexagonal keys generally tend to lose their utility upon completion of the initial tasks, such that they may be confined to use in applications where corresponding female members are present. For instance, retail customers are often provided hexagonal keys with flat pack furniture, for example, for assembly. After such use, a user may have several leftover hexagonal keys. Effective utilization of hexagonal keys is desirable.

### BRIEF SUMMARY

In various implementations, interchangeable tools with robust and efficient form factors enable application of relatively higher torque values and permit more effective utilization of hexagonal keys in narrow and wide spaces.

An interchangeable tool for use with a hexagonal key having at least a first male end with six facets which form a hexagonal profile may be summarized as including a first interchangeable tip. The first interchangeable tip may include a body and a head extending from the body. The body may have a female receptacle having an opening open to an exterior of the first interchangeable tip. The female receptacle may have six facets that form a hexagonal profile sized and dimensioned to matingly receive the first male end of the hexagonal key, with the head having at least one tool element. The tool element may comprise a straight blade screwdriver, a Phillips head screwdriver, a file, a brush, a knife, or a chisel.

The interchangeable tool may include a first permanent magnet coaxially aligned with a central axis of the female receptacle. The interchangeable tool may further include a second permanent magnet and a third permanent magnet. The second and the third permanent magnets may be laterally opposed to one another across the central axis of the female receptacle.

An interchangeable tool set for use with a hexagonal key having at least a first male end with six facets which form with a hexagonal profile may be summarized as including a first interchangeable tip and a second interchangeable tip. The first interchangeable tip may comprise a first body and a first head extending from the first body. The first body may have a first female receptacle having a first opening open to an exterior of the first interchangeable tip. The first female receptacle may have six facets that form a hexagonal profile sized and dimensioned to matingly receive the first male end of the hexagonal key, with the first head forming a straight blade screwdriver. The second interchangeable tip may comprise a second body and a second head extending from the second body. The second body may have a second female receptacle having a second opening open to an exterior of the second interchangeable tip. The second female receptacle may have six facets that form a hexagonal profile sized and dimensioned to matingly receive the first male end of the hexagonal key, with the second head forming a Phillips head screwdriver.

An interchangeable tool connector for use with a hexagonal key having at least a first male end with six facets which form with a hexagonal profile may be summarized as including an interchangeable tool connector body having a first female receptacle having a first opening open to an exterior of the interchangeable tool and a second female receptacle having a second opening positioned opposite to the first opening and open to the exterior of the interchangeable tool. The first and second female receptacles may each have six facets that form a hexagonal profile sized and dimensioned to matingly receive the first male end of the hexagonal key.

### BRIEF DESCRIPTION OF THE SEVERAL VIEWS OF THE DRAWINGS

FIG. 1 is an isometric view of an interchangeable tool coupled to a hexagonal key, according to one embodiment.

FIG. 2 is a front isometric view of the interchangeable tool of FIG. 1.

FIG. 3 is an inverted front isometric view of the interchangeable tool of FIG. 1.

FIG. 4 is a front isometric view of an interchangeable tool, according to another embodiment.

FIG. 5 is a front isometric view of an interchangeable tool, according to another embodiment.

FIG. 6 is a front isometric view of an interchangeable tool, according to another embodiment.

FIG. 7 is a front isometric view of an interchangeable tool, according to another embodiment.

FIG. 8 is a front isometric view of an interchangeable tool, according to another embodiment.

FIG. 9 is a skewed isometric view of an interchangeable tool connector, according to one embodiment.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with tools and related hardware have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense that is as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

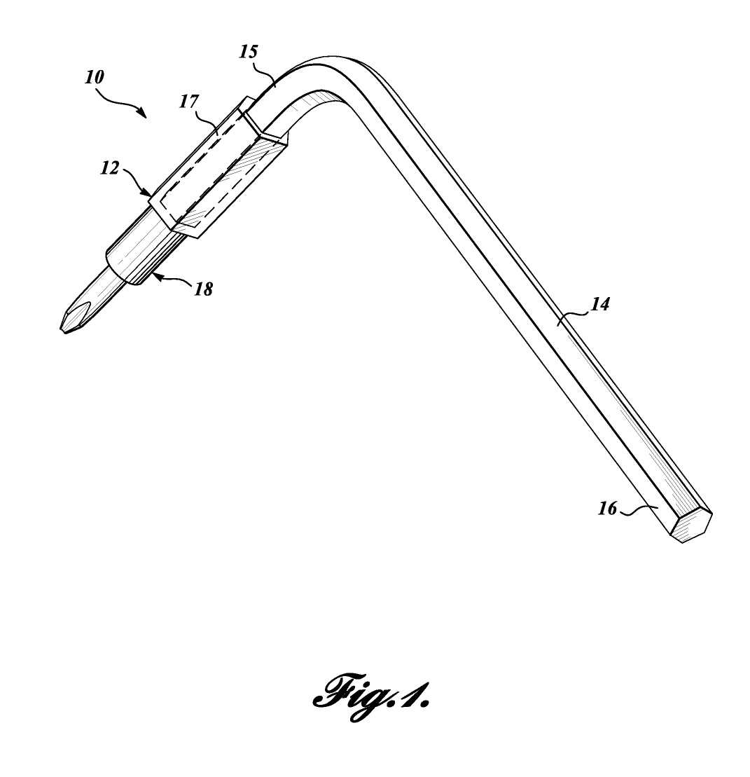

FIG. 1 illustrates an interchangeable tool 10 having an interchangeable tip 12 coupled to a hexagonal key 14. The hexagonal key 14 includes six facets that generally form a hexagonal profile. The illustrated hexagonal key 14 is a right angle key and generally L-shaped, having a first right angle member 15 and a straight handle 16. The first right angle member 15 is substantially perpendicular to the straight handle 16. Although the illustrated hexagonal key 14 is L-shaped, in alternate embodiments, the hexagonal key 14 may be S-shaped, T-shaped, or any other shape or size having a hexagonal profile. For example, in an S-shaped hexagonal key, the hexagonal key may further include a second right angle member. The second right angle member may be substantially perpendicular to the straight handle, but may extend in an opposite direction to the first right angle member. In a T-shaped hexagonal key, for example, the first right angle member may be substantially perpendicular to the straight handle and may extend on either side of a central axis of the straight handle.

The first right angle member 15 or the straight handle 16 of the hexagonal key 14 forms a male end that is matingly receivable by the interchangeable tip 12. Similarly, in an S-shaped hexagonal key, the first and second right angle members may form respective male ends that are matingly receivable by the interchangeable tip 12.

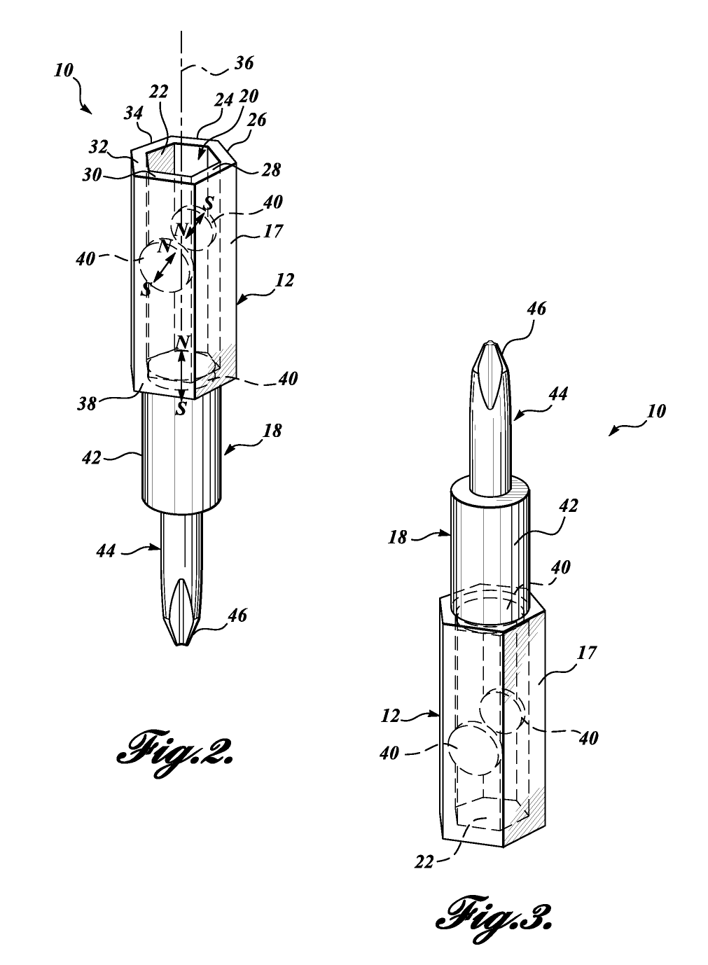

With reference to FIGS. 1 through 3, the interchangeable tip 12 includes a body 17 and a head 18. The body 17 includes six outer facets that circumscribe the outer periphery of the body 17, forming an outer hexagonal profile. At an upper end, the body 17 includes an opening 20 that defines a female receptacle 22 for matingly receiving the hexagonal key 14. The opening 20 has a generally hexagonal profile, which defines six sidewalls 24, 26, 28, 30, 32, 34. The sidewalls 24, 26, 28, 30, 32, 34 are of equal size, with each sidewall aligned opposite another sidewall in a symmetrical arrangement about a central axis 36 of the female receptacle 22 (e.g., 24 and 30, 28 and 34, 26 and 32). The female receptacle 22 is sized longitudinally and laterally to receive a wide variety of hexagonal keys 14. By way of example, the opening 20 may be sized to receive hexagonal keys 14 having hexagonal sizes ranging from ¾″ to 1/20″, for example, and including the standard hexagonal sizes therebetween, or any other suitable hexagonal size. In the axial direction, the female receptacle 22 is sized to have a predetermined depth. This predetermined depth may extend axially, terminating at a sufficient distance from a lower face of the body 17 to define an inner terminus wall 38, which is coaxially aligned with the central axis 36 of the female receptacle 22. In this manner, the predetermined depth may be optimally sized to receive a sufficient portion of the hexagonal key 14 and also have sufficient material in the inner terminus wall 38.

With continued reference to FIGS. 1 through 3, the body 17 optionally includes a plurality of magnets 40 embedded within the body 17. The body 17 includes a magnet 40 embedded and positioned at or within the inner terminus wall 38. Similarly, the body 17 includes magnets 40 embedded and positioned at or within the sidewalls 24 and 30 that are laterally opposed to one another across the central axis 36 of the female receptacle 22. Although in the illustrated embodiment of FIGS. 1-3, the magnets 40 are embedded within the body 17, in alternate embodiments, the body 17 may have apertures, recesses, or the like to receive and/or couple the magnets 40 to the body 17.

The magnets 40 are advantageously selected to produce sufficient magnetic force so as to couple the body 17 to the mating surfaces of the respective hexagonal key 14, where the hexagonal key 14 is typically made from steel or other ferromagnetic materials. In the illustrated embodiment of FIGS. 1-3, the magnets 40 are cylindrical permanent magnets and are axially magnetized (i.e., through the thickness) with the corresponding polarity shown in FIG. 2, for example. In this manner, the magnets 40 produce a magnetic force in a direction that is substantially normal to the mating surfaces of the hexagonal key 14 so as to attract the hexagonal key 14 to the body 17. While the example embodiment includes cylindrical permanent magnets, in alternative embodiments, a bar magnet, a sphere magnet, a radial magnet, or other permanent magnets may be used instead.

In the illustrated embodiment of FIGS. 1-3, two magnets 40 are positioned at or within sidewalls 24, 30 and one magnet 40 is positioned at or within the inner terminus wall 38. In alternate embodiments, any number of magnets may be selected and positioned at or within the sidewalls 24, 26, 28, 30, 32, 34 or the inner terminus wall 38 to provide sufficient coupling magnetic force. Moreover, in alternate embodiments, the sidewalls 24, 26, 28, 30, 32, 34 and the inner terminus wall 38 may include a combination of axially and/or diametrically magnetized magnets to couple the hexagonal key 14 to the body 17. Accordingly, the diametrically and axially magnetized magnets may be configured to have the appropriate polarities so as to attract the hexagonal key 14 to the body 17.

With continued reference to FIGS. 1 through 3, the head 18 includes a shank portion 42 and a tool element 44. The shank portion 42 is cylindrical and extends from a lower end of the body 17. The shank portion 42 is coaxially aligned with the central axis 36 of the female receptacle 22.

The tool element 44 extends from a lower end of the shank portion 42 and is also coaxially aligned with the central axis 36 of the female receptacle 22. The tool element 44 has a cross-shaped tip that is formed by four wedge-shaped concave recesses. The four wedge-shaped recesses converge at the tip of the tool element 44 to define a Phillips screwdriver 46. The cross-shaped tip of the Phillips screwdriver 46 may be sized and shaped to matingly fit into any corresponding recesses formed in a head of a Phillips fastener (e.g., Phillips head (PH) No. 0, PH No. 1, PH No. 2, etc.).

In use, a user may slideably insert either portion (i.e., end of right angle member 15 or straight handle 16) of the hexagonal key 14 through the opening 20 and into the female receptacle 22 of the body 17 to securely couple the interchangeable tip 12 to the hexagonal key 14. The hexagonal key 14 may also be magnetically coupled to the body 17 by the embedded magnets 40. The hexagonal key 14 may advantageously be of any size that may be received within the female receptacle 22, with the magnets 40 being appropriately sized to produce sufficient magnetic force to couple the hexagonal key 14 to the body 17. Alternatively, the user may select an appropriately sized hexagonal key 14 to precisely fit into the corresponding female receptacle 22.

The user may then couple the interchangeable tool 10 to a fastener, for example, which is to be fastened or unfastened. By way of example, the interchangeable tool 10 illustrated in FIGS. 1 through 3 may be used to fasten or unfasten a Phillips head fastener. The Phillips screwdriver 46 may be received in the head of the Phillips fastener. The user may rotate the hexagonal key 14 by leveraging the portion of the hexagonal key 14 that is not received by the female receptacle 22. In this manner, the user may advantageously apply a relatively higher torque than a Phillips screwdriver, for example, to fasten or unfasten the Phillips fastener. Additionally, the user may advantageously access fasteners located in narrow or unreachable spaces that may be inaccessible by the hexagonal key 14 or the Phillips screwdriver, for example, with the interchangeable tool 10 providing an extension.

The interchangeable tool 10 illustrated in FIGS. 1 through 3 may be fabricated of a unitary body of material. The material may include, for example, steel, aluminum, nickel, or other types of metals and alloys. The interchangeable tool 10 may be formed via various manufacturing methods, such as, for example, various machining, casting, forging, or molding processes. Alternatively, the various components of the interchangeable tool 10 (e.g., body 17, shank portion 42, tool element 44, etc.) may be coupled together through coupling means, such as, for example, welding, fastening, adhering, etc.

FIG. 4 illustrates an interchangeable tool 110 having an interchangeable tip 112, according to an alternate embodiment. The interchangeable tip 112 includes a body 117 and a head 118. The body 117 includes an opening 120 that defines a female receptacle 122 for matingly receiving a head or end of the hexagonal key 14 and optionally includes a plurality of magnets embedded in the body 117 (not shown). The head 118 includes a shank portion 142 and a tool element 144.

FIG. 4 illustrates a variation in which the head 118 includes the tool element 144 extending from a lower end of the shank portion 142. The tool element 144 includes a wire core 145 with a plurality of fibers 147, such as bristles, for example. The plurality of fibers 147 radially extend outward from the wire core 145 to form a wire brush 149. The plurality of fibers 147 may comprise steel fibers, nylon fibers, Teflon fibers, polypropylene fibers, or other suitable material fibers. The wire core 145 may be formed by two or more separate wires, which may be twisted together to form a helix. The plurality of fibers 147 are held between the wires. Alternatively, the wire core 145 may be formed by a single wire bent into a U-shape or a C-shape protruding from the lower end of the shank portion 142. This single wire may then be twisted to form a helix, having the fibers extending radially outward therefrom.

A user may slideably insert a head or end of the hexagonal key 14 in the female receptacle 122 of the body 117. Again, the hexagonal key 14 may be of any size or shape. In this manner, the user may rotate the hexagonal key 14 to rotate the wire brush 149 to clean various components located in narrow or wide spaces, such as, for example, removing rust from metal parts, cleaning electronic or computer components, and other suitable uses.

Again, the interchangeable tool 110 illustrated in FIG. 4 may be fabricated of a unitary body of material, further including a plurality of fibers 147 radially extending from the wire core 145. The material may include, for example, steel, aluminum, nickel, or other types of metals and alloys. The interchangeable tool 110 may be formed via various manufacturing methods, such as, for example, various machining, casting, forging, or molding processes. Alternatively, the various components of the interchangeable tool 110 (e.g., body 117, shank portion 142, tool element 144, etc.) may be coupled together through coupling means, such as, for example, welding, fastening, adhering, etc.

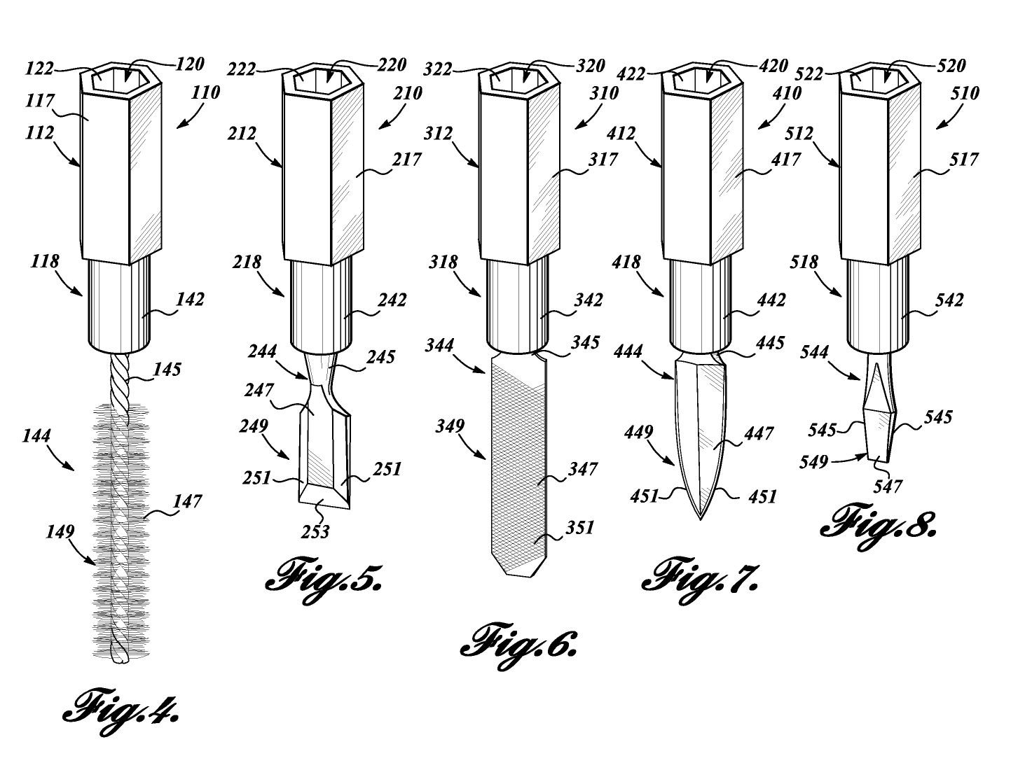

FIG. 5 illustrates an interchangeable tool 210 having an interchangeable tip 212, according to an alternate embodiment. The interchangeable tip 212 includes a body 217 and a head 218. The body 217 includes an opening 220 that defines a female receptacle 222 for matingly receiving a head or end of the hexagonal key 14 and optionally includes a plurality of magnets embedded in the body 217 (not shown). The head 218 includes a shank portion 242 and a tool element 244.

FIG. 5 illustrates a variation in which the head 218 includes the tool element 244 extending from a lower end of the shank portion 242. The tool element 244 includes a neck portion 245 and a main body portion 247, forming a chisel 249. The neck portion 245 gradually tapers inwardly as it transitions to the main body portion 247. The main body portion 247 includes two side cutting blades 251 that are positioned opposite to one another. Each of the side cutting blades 251 is beveled to form side cutting surfaces. At a lower portion, the main body portion 247 includes a leading edge cutting blade 253. Again, the leading edge cutting blade 253 is beveled to form a leading edge cutting surface.

A user may slideably insert a head or end of a hexagonal key 14 in the female receptacle 222 of the body 217. Again, the hexagonal key 14 may be of any size or shape. In this manner, the user may use the interchangeable tool 210 for cutting, carving, or shaving various workpieces located in narrow or wide spaces.

Again, the interchangeable tool 210 illustrated in FIG. 5 may be fabricated of a unitary body of material. The material may include, for example, steel, aluminum, nickel, or other types of metals and alloys. The interchangeable tool 210 may be formed via various manufacturing methods, such as, for example, various machining, casting, forging, or molding processes. Alternatively, the various components of the interchangeable tool 210 (e.g., body 217, shank portion 242, tool element 244, etc.) may be coupled together through coupling means, such as, for example, welding, fastening, adhering, etc.

FIG. 6 illustrates an interchangeable tool 310 having an interchangeable tip 312, according to an alternate embodiment. The interchangeable tip 312 includes a body 317 and a head 318. The body 317 includes an opening 320 that defines a female receptacle 322 for matingly receiving a head or end of the hexagonal key 14 and optionally includes a plurality of magnets embedded in the body 317 (not shown). The head 318 includes a shank portion 342 and a tool element 344.

FIG. 6 illustrates a variation in which the head 318 includes the tool element 344 extending from a lower end of the shank portion 342. The tool element 344 includes a tang 345 and a blade 347 to form a file 349, such as a metal file or a wood file, for example. The tang 345 protrudes from the shank portion 342, generally tapering inwardly as it transitions to the blade 347. The blade 347 includes a plurality of teeth 351 that may be arranged in any suitable manner, with the number, size, and orientation of teeth, for example, reflective of the coarseness of the file 349. While the file 349 illustrated in FIG. 6 is generally a hand file, in alternative embodiments, the file may be a flat, pillar, round, square, triangular, knife edge, or any other type of file.

A user may slideably insert a head or end of a hexagonal key 14 in the female receptacle 322 of the body 317. Again, the hexagonal key 14 may be of any size or shape. In this manner, the user may repeatedly move the interchangeable tool 310 when in contact with a workpiece for cutting, smoothing, or removing material from the workpiece located in narrow or wide spaces.

Again, the interchangeable tool 310 illustrated in FIG. 6 may be fabricated of a unitary body of material. The material may include, for example, steel, aluminum, nickel, or other types of metals and alloys. The interchangeable tool 310 may be formed via various manufacturing methods, such as, for example, various machining, casting, forging, or molding processes. Alternatively, the various components of the interchangeable tool 310 (e.g., body 317, shank portion 342, tool element 344, etc.) may be coupled together through coupling means, such as, for example, welding, fastening, adhering, etc.

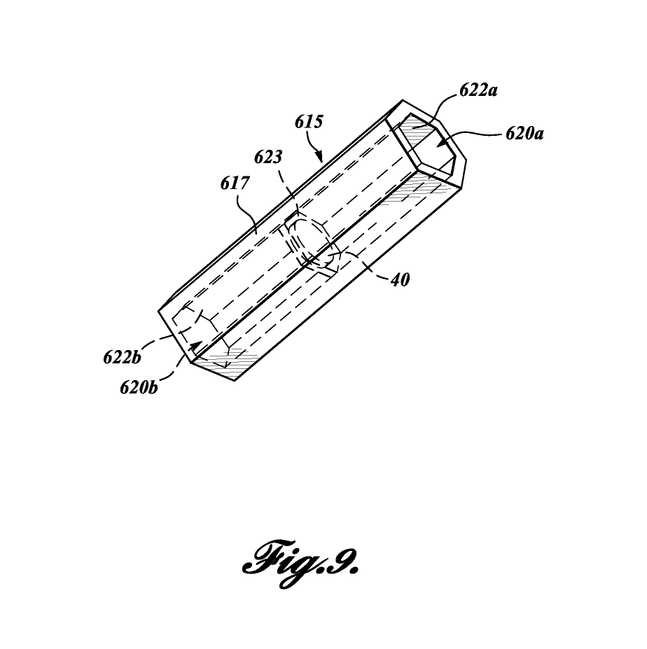

FIG. 7 illustrates an interchangeable tool 410 having an interchangeable tip 412, according to an alternate embodiment. The interchangeable tip 412 includes a body 417 and a head 418. The body 417 includes an opening 420 that defines a female receptacle 422 for matingly receiving a head or end of the hexagonal key 14 and optionally includes a plurality of magnets embedded in the body 417 (not shown). The head 418 includes a shank portion 442 and a tool element 444.

FIG. 7 illustrates a variation in which the head 418 includes the tool element 444 extending from a lower end of the shank portion 442. The tool element 444 includes a tang 445 and a blade 447 to form a knife 449. The tang 445 generally tapers inwardly as it transitions to the blade 447. The blade 447 includes cutting edges 451 that are positioned at a periphery of the blade 447 and opposite one another. The cutting edges 451 generally extend in an arcuate manner converging at a tip of the blade 447. While the knife 449 illustrated in FIG. 7 includes a double-edge blade, in alternate embodiments, the knife 449 may include a clip point blade, drop point blade, spey point blade, or other forms of knife blades.

A user may slideably insert a head or end of a hexagonal key 14 in the female receptacle 422 of the body 417. Again, the hexagonal key 14 may be of any size or shape. In this manner, the user may use the interchangeable tool 410 for cutting, carving, or shaving various workpieces located in narrow or wide spaces.

Again, the interchangeable tool 410 illustrated in FIG. 7 may be fabricated of a unitary body of material. The material may include, for example, steel, aluminum, nickel, or other types of metals and alloys. The interchangeable tool 410 may be formed via various manufacturing methods, such as, for example, various machining, casting, forging, or molding processes. Alternatively, the various components of the interchangeable tool 410 (e.g., body 417, shank portion 442, tool element 444, etc.) may be coupled together through coupling means, such as, for example, welding, fastening, adhering, etc.

FIG. 8 illustrates an interchangeable tool 510 having an interchangeable tip 512, according to an alternate embodiment. The interchangeable tip 512 includes a body 517 and a head 518. The body 517 includes an opening 520 that defines a female receptacle 522 for matingly receiving a head or end of the hexagonal key 14 and optionally includes a plurality of magnets embedded in the body 417 (not shown). The head 518 includes a shank portion 542 and a tool element 544.

FIG. 8 illustrates a variation in which the head 518 includes the tool element 544 extending from a lower end of the shank portion 542. The tool element 544 includes tapering side edges 545 that are opposite to one another. The tapering side edges 545 terminate to form a substantially flat engaging edge 547 to define a flat head screwdriver 549. The engaging edge 547 of the flat head screwdriver 549 may be sized and shaped to matingly fit into any corresponding recesses formed in a slotted head of a corresponding fastener.

A user may slideably insert a head or end of a hexagonal key 14 in the female receptacle 522 of the body 517. Again, the hexagonal key 14 may be of any size or shape. In this manner, the user may rotate the hexagonal key 14 to fasten or unfasten appropriate fasteners located in narrow or wide spaces by applying the necessary torque.

Again, the interchangeable tool 510 illustrated in FIG. 8 may be fabricated of a unitary body of material. The material may include, for example, steel, aluminum, nickel, or other types of metals and alloys. The interchangeable tool 510 may be formed via various manufacturing methods, such as, for example, various machining, casting, forging, or molding processes. Alternatively, the various components of the interchangeable tool 510 (e.g., body 517, shank portion 542, tool element 544, etc.) may be coupled together through coupling means, such as, for example, welding, fastening, adhering, etc.

FIG. 9 illustrates an example embodiment of an interchangeable tool connector 615. The interchangeable tool connector 615 includes a body 617. The body 617 includes six outer facets that circumscribe the outer periphery of the body 617, forming an outer hexagonal profile. At one end, the body 617 includes a first opening 620a that defines a first female receptacle 622a for matingly receiving a head or end of the hexagonal key 14. At an opposite end, the body 617 includes a second opening 620b that defines a second female receptacle 622b for matingly receiving a head or end of another hexagonal key 14. The first female receptacle 622a and the second female receptacle 622b are coaxially aligned with each other along their respective central axes. Both the first and second female receptacles 622a, 622b are sized longitudinally and laterally to receive a wide variety of hexagonal keys 14.

In the axial direction, the first female receptacle 622a is sized to have a first predetermined depth. The second female receptacle 622b is sized to have a second predetermined depth in the axial direction, extending in an opposite direction to the first predetermined depth to define a divider wall 623. The divider wall 623 is coaxially aligned with the central axes of the first and second female receptacles 622a, 622b. In this manner, the first and second predetermined depths may be optimally sized to receive a sufficient portion of the hexagonal key 14 and also have sufficient material in the divider wall 638.

The body 617 optionally includes a magnet 40 embedded and positioned at or within the divider wall 638. Although in the illustrated embodiment of FIG. 9, the magnet 40 is embedded within the body 617, in alternate embodiments, the body 617 may have apertures, recesses, or the like to receive and/or couple the magnets 40 to the body 617.

The magnet 40 is advantageously selected to produce sufficient magnetic force so as to couple the body 617 to the mating surfaces of the respective hexagonal keys 14. Again, while the magnet 40 illustrated in FIG. 9 is a cylindrical permanent magnet that is axially magnetized, in alternative embodiments, a bar magnet, a sphere magnet, a radial magnet, or other permanent magnets may be used instead. Further, in some embodiments, the body 617 may include any number of magnets positioned at or within the respective sidewalls and/or divider wall 638 of the body 617. Still further, in some embodiments, the body 617 may also include a combination of axially and/or diametrically magnetized magnets to couple the hexagonal keys 14 to the body 617.

A user may slideably insert a heard or end of a first hexagonal key 14 (e.g., L-shaped, S-shaped, T-shaped, etc.) in the first female receptacle 622a of the body 617. The user may then insert a head or end of a second hexagonal key 14 (e.g., L-shaped, S-shaped, T-shaped, etc.) in the second female receptacle 622b of the body 617. The user may then securely couple an end of either the first or second hexagonal keys 14 that is not received in the interchangeable tool connector 615 to an interchangeable tool or may directly couple to a corresponding fastener. In this manner, an overall length of the hexagonal keys 14 may be lengthened to advantageously provide greater leverage and torque when fastening or unfastening corresponding fasteners, for example. Additionally, the user may advantageously access fasteners or workpieces located in narrow spaces that may otherwise be unreachable or difficult to access.

Again, the interchangeable tool connector 615 illustrated in FIG. 9 may be fabricated of a unitary body of material. The material may include, for example, steel, aluminum, nickel, or other types of metals and alloys. The interchangeable tool connector 615 may be formed via various manufacturing methods, such as, for example, various machining, casting, forging, or molding processes. Alternatively, the various components of the interchangeable tool connector 615 may be coupled together through coupling means, such as, for example, welding, fastening, adhering, etc.

Various embodiments of the interchangeable tools have been illustrated. However, interchangeable tools of other configurations may be employed. For example, in some embodiments the interchangeable tools may have openings with other polygonal profiles, such as a square opening, for example, to receive corresponding male ends. Further, in some embodiments, the interchangeable tools may be adapted to receive male ends having a spring loaded ball detent system, for example. Such embodiments of the interchangeable tools may include recesses or cavities for receiving the ball detent to secure the male end to the interchangeable tools. Still further, in some embodiments, the interchangeable tools may include a tool element with a hexagonal shaped profile to be received by corresponding fasteners.

The various components described herein may advantageously be provided as an interchangeable tool set. The interchangeable tool set may, for example, include any number and/or combination of interchangeable tips 12, 112, 212, 312, 412, 512. The interchangeable tool set may also include any number and/or combination of interchangeable tips 14, 114, 214, 314, 414, 514, 614 having various female receptacles of various hexagonal sizes. The interchangeable tool set may also include hexagonal keys of various sizes and shapes. For example, the hexagonal keys may be of the L-shaped, T-shaped, or S-shaped variety. Such hexagonal keys may also have a wide variety of hexagonal sizes. The interchangeable tool set may also include any number and/or combination of interchangeable tool connectors 615 having various female receptacles of various hexagonal sizes.

Moreover, these and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. An interchangeable tool for use with a hexagonal key, the hexagonal key having at least a first male end with six facets which form a hexagonal profile, comprising:
a first interchangeable tip, the first interchangeable tip comprising a body and a head extending from the body, the body having a female receptacle having an opening open to an exterior of the first interchangeable tip, the female receptacle having six facets that form a hexagonal profile sized and dimensioned to matingly receive the first male end of the hexagonal key, and the head having at least one tool element.

2. The interchangeable tool of claim 1 wherein the body and the head are a single unitary piece of metal.

3. The interchangeable tool of claim 1, further comprising:
a first permanent magnet coaxially aligned with a central axis of the female receptacle.

4. The interchangeable tool of claim 3 wherein the first permanent magnet is positioned at an inner terminus of the female receptacle.

5. The interchangeable tool of claim 4, further comprising:
a second permanent magnet; and
a third permanent magnet, the second and the third permanent magnets laterally opposed to one another across the central axis of the female receptacle.

6. The interchangeable tool of claim 5 wherein the second and the third permanent magnets are spaced between the inner terminus and the opening of the female receptacle.

7. The interchangeable tool of claim 1 wherein the at least one tool element is at least one screwdriver blade.

8. The interchangeable tool of claim 1 wherein the at least one tool element is selected from the group consisting of a straight blade screwdriver or a Phillips head screwdriver.

9. The interchangeable tool of claim 1 wherein the at least one tool element is chisel blade.

10. The interchangeable tool of claim 1 wherein the at least one tool element is a brush.

11. The interchangeable tool of claim 1 wherein the at least one tool element is a knife.

12. The interchangeable tool of claim 1 wherein the at least one tool element is a file.

13. An interchangeable tool set for use with a hexagonal key, the hexagonal key having at least a first male end with six facets which form a hexagonal profile, comprising:
a first interchangeable tip, the first interchangeable tip comprising a first body and a first head extending from the first body, the first body having a first female receptacle having a first opening open to an exterior of the first interchangeable tip, the first female receptacle having six facets that form a hexagonal profile sized and dimensioned to matingly receive the first male end of the hexagonal key, and the first head forms a straight blade screwdriver; and
a second interchangeable tip, the second interchangeable tip comprising a second body and a second head extending from the second body, the second body having a second female receptacle having a second opening open to an exterior of the second interchangeable tip, the second female receptacle having six facets that form a hexagonal profile sized and dimensioned to matingly receive the first male end of the hexagonal key, and the second head forms a Phillips head screwdriver.

14. The interchangeable tool of claim 13 wherein each of the first and the second interchangeable tips each include a respective first permanent magnet coaxially aligned with a respective central axis of the first and the second female receptacle, respectively.

15. The interchangeable tool of claim 14 wherein the first permanent magnet is positioned at an inner terminus of the first and the second female receptacle, respectively.

16. The interchangeable tool of claim 15 wherein each of the first and the second interchangeable tips each include a respective second and third permanent magnet, the second and the third permanent magnets laterally opposed to one another across the central axis of the first and the second female receptacle, respectively.

17. The interchangeable tool set of claim 13, further comprising:
a third interchangeable tip, the third interchangeable tip comprising a third body and a third head extending from the third body, the third body having a third female receptacle having a third opening open to an exterior of the third interchangeable tip, the third female receptacle having six facets that form a hexagonal profile sized and dimensioned to matingly receive the first male end of the hexagonal key, and the third head having a plurality of bristles that form a brush.

18. The interchangeable tool set of claim 17, further comprising:
a fourth interchangeable tip, the fourth interchangeable tip comprising a fourth body and a fourth head extending from the fourth body, the fourth body having a fourth female receptacle having a fourth opening open to an exterior of the fourth interchangeable tip, the fourth female receptacle having six facets that form a hexagonal profile sized and dimensioned to matingly receive the first male end of the hexagonal key, and the fourth head which forms a chisel blade.

19. The interchangeable tool set of claim 19, further comprising:
a fifth interchangeable tip, the fifth interchangeable tip comprising a fifth body and a fifth head extending from the fifth body, the fifth body having a fifth female receptacle having a fifth opening open to an exterior of the fifth interchangeable tip, the fifth female receptacle having six facets that form a hexagonal profile sized and dimensioned to matingly receive the first male end of the hexagonal key, and the fifth head which forms a knife.

20. The interchangeable tool set of claim 19, further comprising:
a sixth interchangeable tip, the sixth interchangeable tip comprising a sixth body and a sixth head extending from the sixth body, the sixth body having a sixth female receptacle having a sixth opening open to an exterior of the sixth interchangeable tip, the sixth female receptacle having six facets that form a hexagonal profile sized and dimensioned to matingly receive the first male end of the hexagonal key, and the sixth head which forms a file.

21. The interchangeable tool set of claim 13, further comprising:
the hexagonal key.

22. The interchangeable tool set of claim 21 wherein the hexagonal key includes a straight handle, and the first male end extends at a right angle to the straight handle.

23. The interchangeable tool set of claim 22 wherein the hexagonal key has a second male end with six facets which form a hexagonal profile, and the second male end extends at a right angle to the straight handle in a direction opposite from a direction that the first male end extends from the straight handle.

24. The interchangeable tool set of claim 13 wherein the first body and the first head of the first interchangeable tool tip are a single unitary piece of metal and the second body and the second head of the second interchangeable tool tip are a single unitary piece of metal.

25. The interchangeable tool set of claim 13, further comprising:
an interchangeable tool connector having an interchangeable tool body, the interchangeable tool body having a first female receptacle having a first opening open to an exterior of the interchangeable tool and a second female receptacle having a second opening positioned opposite to the first opening and open to the exterior of the interchangeable tool, the first and second female receptacles each having six facets that form a hexagonal profile sized and dimensioned to matingly receive the first male end of the hexagonal key.

26. An interchangeable tool connector for use with a hexagonal key, the hexagonal key having at least a first male end with six facets which form a hexagonal profile, comprising:
an interchangeable tool connector body having a first female receptacle having a first opening open to an exterior of the interchangeable tool and a second female receptacle having a second opening positioned opposite to the first opening and open to the exterior of the interchangeable tool, the first and second female receptacles each having six facets that form a hexagonal profile sized and dimensioned to matingly receive the first male end of the hexagonal key.

27. The interchangeable tool connector of claim 26 wherein the first female receptacle extends coaxially along a respective central axis of the first female receptacle and the second female receptacle extends coaxially in a direction opposite to the first female receptacle along a respective central axis of the second female receptacle to define a divider.

28. The interchangeable tool connector of claim 27, further comprising:
a permanent magnet positioned at the divider and coaxially aligned with the respective axes of the first and second female receptacles.
